(19) United States
(12) Patent Application Publication
(10) Pub. No.: US 2023/0011410 A1
(43) Pub. Date: Jan. 12, 2023

(54) METHODS AND APPARATUS FOR CLEARING SURFACES OF SENSORS

(71) Applicant: NURO, INC., Mountain View, CA (US)

(72) Inventors: Aryamitra R. Bake, San Jose, CA (US); Andrew Bryce Braum, Los Gatos, CA (US); Peter Jon Kardassakis, Mountain View, CA (US); Joseph Daniel Penniman, Santa Clara, CA (US); Vignesh Suresh, Sunnyvale, CA (US)

(73) Assignee: NURO, INC., Mountain View, CA (US)

(21) Appl. No.: 17/862,340

(22) Filed: Jul. 11, 2022

Related U.S. Application Data
(60) Provisional application No. 63/220,761, filed on Jul. 12, 2021.

(51) Int. Cl. B60S 1/56

(52) U.S. Cl. CPC B60S 1/56; G01S 17/931

(57) ABSTRACT

According to one aspect, a sensor clearing system is arranged to remove precipitation and/or other contamination from a sensor. A sensor clearing system which is suitable for use on an autonomous vehicle includes an axial fan and a duct arrangement. The axial fan is configured to provide air flow that is routed through the duct arrangement. The duct arrangement directs the air flow towards a sensor, e.g., a lidar, at a velocity and/or with a force that is selected to cause any precipitation on a surface of the sensor, e.g., a lens of a lidar, to be removed.

### CROSS-REFERENCE TO RELATED APPLICATIONS

This application claims the benefit of Provisional U.S. Application Ser. No. 63/220,761, filed on Jul. 12, 2021, and titled “METHODS AND APPARATUS FOR CLEARING SURFACES OF SENSORS”; the aforementioned priority application being hereby incorporated by reference in its entirety.

### TECHNICAL FIELD

The disclosure relates to providing systems for use with autonomous vehicles. More particularly, the disclosure relates to systems used to clear the surfaces of sensors on autonomous vehicles.

### BACKGROUND

Sensors are often exposed to environmental factors such as precipitation, e.g., rainfall. For example, sensors used to enable autonomous vehicles to operate are generally exposed to the environment as the autonomous vehicles travel. When a sensor is subjected to precipitation, the performance of the sensor may be compromised. When the performance of a sensor on an autonomous vehicle is compromised, the ability for the autonomous vehicle to operate safely and efficiently may be adversely affected.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram representation of a sensor unit, e.g., sensor unit 316 of FIG. 3, in accordance with an embodiment.

FIGS. 5A-D illustrate an example of a sensor unit, e.g., sensor unit 316 of FIGS. 3 and 4, in accordance with embodiments.

FIGS. 5E-F illustrate another example of a sensor unit, e.g., sensor unit 316 of FIGS. 3 and 4, in accordance with embodiments.

FIGS. 6A-G are diagrammatic representations of examples of a portion of the duct arrangement, in accordance with embodiments.

FIG. 7A-C are diagrammatic representations of examples of another portion of the duct assembly, in accordance with embodiments.

FIG. 8A is a diagrammatic representation of a sensor unit with a duct subassembly which cooperates with a fan arrangement to guide air flow over a surface of a sensor in accordance with an embodiment.

FIG. 8B is a diagrammatic representation of a sensor unit with a duct subassembly, e.g., sensor unit 816 of FIG. 8A, at a time t1 when precipitation is sensed on a surface of a sensor in accordance with an embodiment.

FIG. 8C is a diagrammatic representation of a sensor unit with a duct subassembly, e.g., sensor unit 816′ of FIG. 8B, at a time t2 when precipitation and/or contamination is removed from a surface of a sensor in accordance with an embodiment.

FIG. 9 is a process flow diagram which illustrates a method of clearing a surface of a sensor in accordance with an embodiment.

FIG. 10 is block diagram representation of sensor clearing systems of an autonomous vehicle, in accordance with embodiments.

### DESCRIPTION OF EXAMPLE EMBODIMENTS

General Overview

In one embodiment, a sensor clearing system is arranged to remove precipitation from a sensor. A sensor clearing system which is suitable for use on an autonomous vehicle includes an axial fan and a duct arrangement. The axial fan is configured to provide air flow that is routed through the duct arrangement. The duct arrangement directs the air flow towards a sensor, e.g., a lidar, at a velocity and/or with a force that is selected to cause any precipitation on a surface of the sensor, e.g., a lens of a lidar, to be removed.

In another embodiment, a sensor unit comprises a fan, a sensor having a sensor window, and a duct assembly to which the sensor and the fan are attached. A duct that is arranged to direct air from the fan towards the sensor window is at least partially formed between the duct assembly and the sensor.

In yet another embodiment, a sensor mount comprises two separable pieces including a first piece that is suitable for attaching to a sensor and a second piece that is suitable for attaching to a fan. The first and second pieces of the sensor mount, when assembled, form a first portion of a duct for directing air from the fan towards the sensor. When the sensor is attached to the sensor mount, the sensor and the sensor mount form a second portion of the duct.

In still a further embodiment, an autonomous vehicle comprises a sensor unit and a perception system. The sensor unit includes a sensor having a sensor window, a fan, and a duct assembly to which the sensor and the fan are attached. The perception system is configured to receive sensor data from the sensor and other sensors onboard the autonomous vehicle. And a duct that is arranged to direct air from the fan towards the sensor window is at least partially formed between the duct assembly and the sensor.

Description

Autonomous vehicles generally include a myriad of sensors which are exposed to the environment in which the autonomous vehicles operate. Sensors may include, but are not limited to including, lidar, radar, a still image camera, a video camera, an ultrasonic sensor, a microphone, an altimeter, and a depth finder. Sensors may be exposed to precipitation such as liquid precipitation, freezing precipitation, and frozen precipitation. Liquid precipitation generally includes rain and drizzle. Freezing precipitation generally includes freezing rain, freezing drizzle, and slush. Frozen precipitation generally includes snow, ice, sleet, and hail. Sensors may also be exposed to other forms of contamination such as dust, debris, and the like.

Substantially weatherproofing sensors that are used on autonomous vehicles, or otherwise mitigating effects of weather on sensors, is critical to ensure that the performance of the sensors is not compromised when exposed to adverse weather conditions. For example, when precipitation such as rain comes into contact with a lidar unit, the range at which the lidar unit may operate is typically reduced. For instance, a point cloud intensity associated with the lidar unit may be adversely affected. Thus, the performance of a lidar unit may be compromised when precipitation comes into contact with a surface, e.g., a sensing surface, of the lidar unit.

Mechanical mechanisms which are used remove precipitation from the sensors generally come into physical contact with the sensors. As a result, mechanical mechanisms such as wipers typically create friction and, thus, may scratch the sensors. The accuracy with which sensors operate may be compromised when the sensors are scratched.

The ability to effectively mitigate the effects of precipitation and/or contamination on sensors using methods which do not require physical contact with the surface of a sensor generally allows the sensors to be substantially weatherproofed without causing damage to the sensor. In one embodiment, a clearing system may provide an air flow across a surface, e.g., a lens surface, of a sensor unit such as a lidar unit. An air curtain may effectively blow air over a surface of a sensor to remove precipitation from the surface, and may also substantially prevent some precipitation from coming into contact with the surface by causing the precipitation to be deflected away from, or blown away from, the surface. Thus, precipitation such as a raindrop is prevented from coming into contact with a sensor. The air flow may substantially form an air curtain that protects a sensor, and may be provided through an arrangement that includes at least one fan arrangement and a duct system which effectively causes air from the fan arrangement to create airflow of a relatively high velocity, e.g., a velocity that is sufficient to remove precipitation from the surface of the sensor. The airflow, which may be a laminar air flow, may be provided at a relatively high velocity continuously while there is precipitation. The duct system may generally cause the airflow to be directed towards a surface of a sensor with a desired air velocity and/or air pressure.

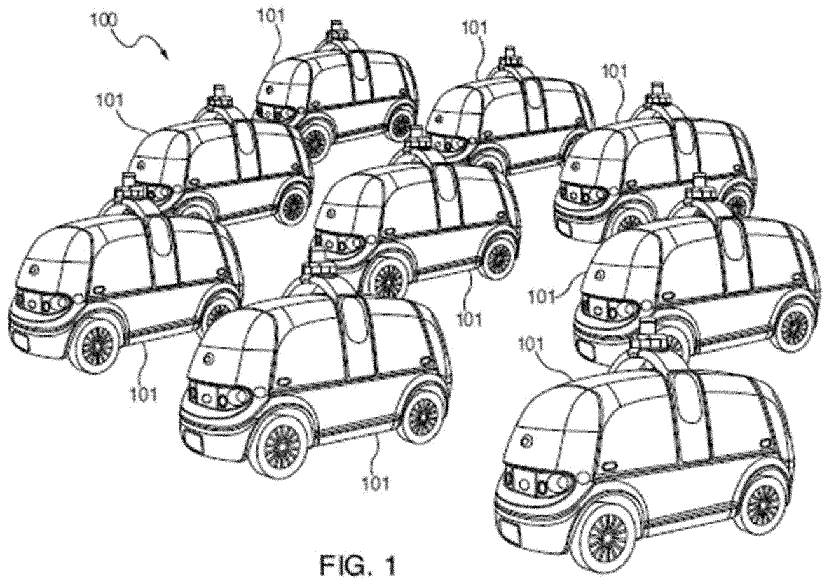

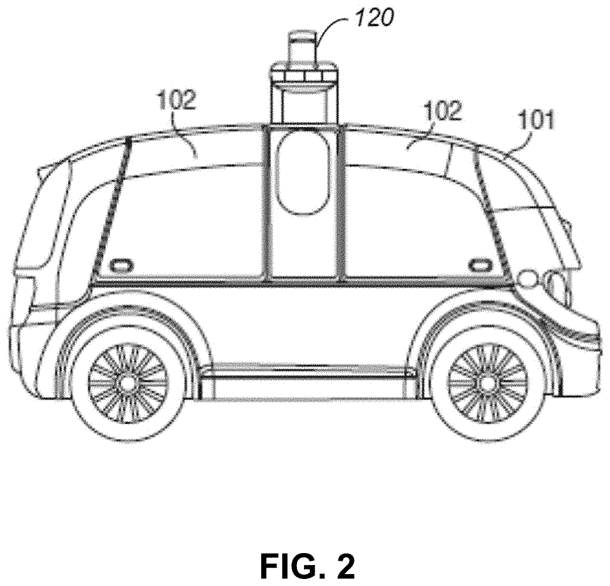

Autonomous vehicles are often part of a fleet of autonomous vehicles which may be dispatched by a fleet management system. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

Autonomous vehicle 101 generally includes suites of sensors which are used to facilitate the autonomous operation of autonomous vehicle 101. Sensors may generally be located substantially anywhere on autonomous vehicle 101. As shown, a sensor pod 120 may be positioned atop autonomous vehicle 101. Sensor pod 120 may include any number of different sensors, and may include at least one lidar unit.

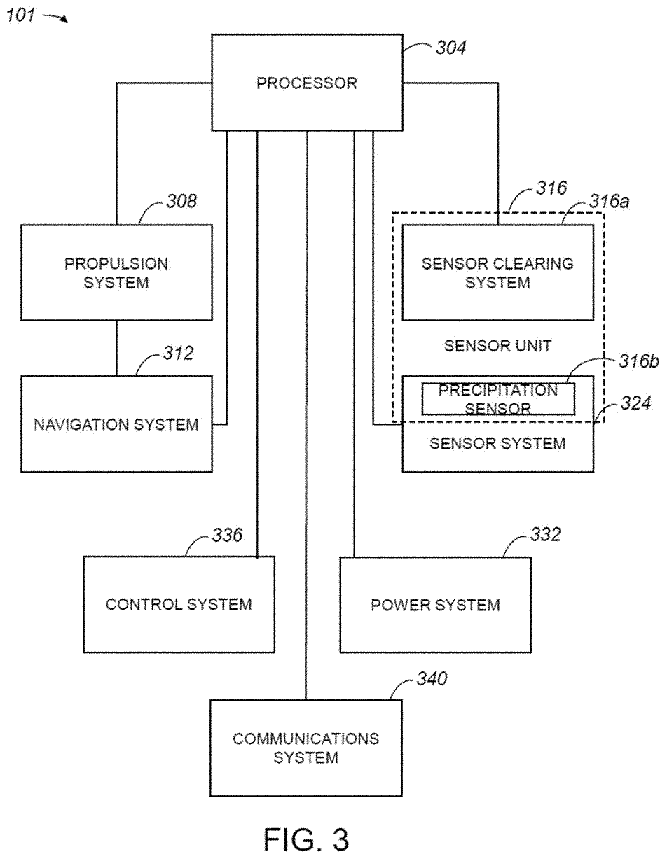

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor clearing system 316, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example lidar, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101. In one embodiment, sensor system 324 includes a precipitation sensor 316b which is configured to operate as part of a sensor unit 316 which also includes sensor clearing system 316a. In one embodiment, a lidar unit is included in a portion of sensor system 324 that is part of sensor unit 316 such that the lidar unit is protected from precipitation by an air flow provided by sensor clearing system 316a.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

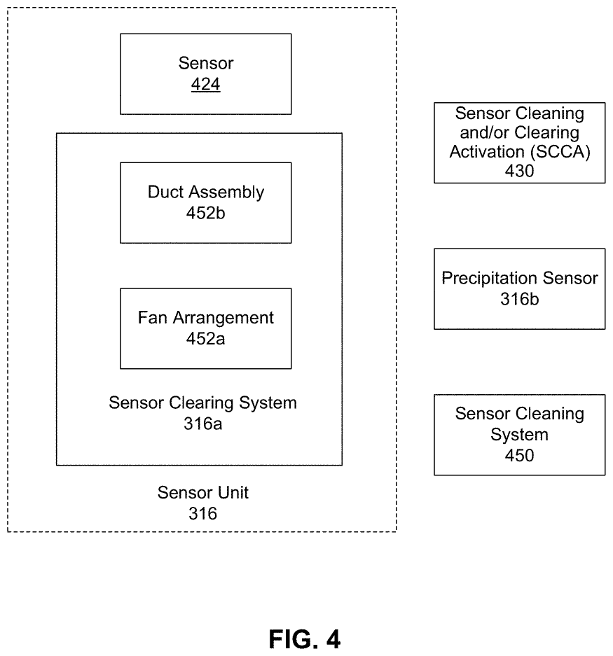

Sensor unit 316 will be described in more detail with respect to FIG. 4. FIG. 4 is a block diagram representation of a sensor unit 316 in accordance with an embodiment. Sensor unit 316 includes a sensor 424, which may be a lidar unit, and sensor clearing system 316a. A precipitation sensor 316b may also be a part of the sensor unit or may be provided on the autonomous vehicle 101 separately from the sensor unit 316. Sensor 424 includes at least one surface that is arranged to be cleared using sensor clearing system 316a. Such a surface may be a lens, a sensor window, or any surface on the exterior of the sensor unit which, when covered by debris, dust, or precipitation, may affect the accuracy and sensing capability of the sensor 424. In one embodiment, sensor 424 may be a lidar unit mounted atop an autonomous vehicle. In particular, the sensor 424 may be a cylindrical LiDAR configured to rotate about an axis in order to scan and generate sensor data (e.g., point cloud data) over an angular sensing range (e.g., 360 degrees, 270 degrees, etc.). Precipitation sensor 316b which be substantially any sensor which may sense the presence of precipitation, e.g., the presence of a raindrops, and/or moisture in general.

According to embodiments, sensor clearing system 316a may include a duct assembly 452b (e.g., a mount and duct assembly) and may further include a fan arrangement 452a. Fan arrangement 452a is configured to cause or generate an air flow when activated or powered on. For example, when precipitation sensor 316b detects precipitation, precipitation sensor 316b may cause fan arrangement 452a to activate or power on. In one embodiment, fan arrangement 452a includes an axial fan. As will be appreciated by those skilled in the art, an axial fan is generally configured to cause a gas, e.g., air, to substantially flow through the fan, due to a pressure difference, in an axial direction, while parallel to a shaft about which blades of the fan rotate. Fan arrangement 452a includes any number of fans. The fans included in fan arrangement 452a may be powered by a power system of an autonomous vehicle, e.g., power system 332 of FIG. 3. Alternatively, fan arrangement 452a may be powered using a separate power system that is substantially dedicated to fan arrangement 452a. The fan(s) of the fan arrangement 452a may be an axial fan(s), a bladeless fan(s) (e.g., an air multiplier unit(s)), an air mover(s), or of any type or configuration.

According to embodiments, the vehicle 101 may further comprise a sensor cleaning system 450 that is configured to apply a fluid (e.g., a cleaning solution) to an exterior of the sensor 424 (e.g., a sensor window). The sensor cleaning may be activated or triggered to apply the fluid in response to an indication that an exterior (e.g., a sensor window) of the sensor 424 is contaminated by debris or dust. For instance, the sensor data generated by the sensor 424 may be analyzed to determine that the sensor window of the sensor 424 is contaminated and, in response, the sensor cleaning system may be activated or triggered. In certain implementations, the sensor cleaning system may be shared by multiple sensors (e.g., radar, LiDAR, cameras) but may be configurable to be activated or triggered to apply cleaning fluid on a per-sensor basis. For example, the perception system (or another system of the autonomous vehicle 101) may be able to determine, based on sensor data generated by individual sensors of the autonomous vehicle 101 whether to activate or trigger the sensor cleaning system for the sensors to apply cleaning fluid on a per-sensor basis.

In various implementations, the sensor clearing system 316a for a particular sensor 424 may be activated or triggered after the sensor cleaning system was triggered to apply cleaning fluid on the exterior (e.g., on a sensor window) of the sensor 424. For instance, the sensor clearing system 316a for the sensor 424 may be activated or triggered a predetermined amount of time (e.g., 0.5 seconds, 1 second, 3 seconds, etc.) after the sensor cleaning system applies fluid to the sensor window of the sensor 424 to clear the fluid that was applied by the sensor cleaning system. As discussed herein, the sensor clearing system 316a may be further configured to operate when the sensor cleaning system is not activated or triggered. In other words, the sensor clearing system 316a may be activated independently from the sensor cleaning system. For example, the sensor clearing system 316a may be activated or triggered to clear precipitation or dust from the exterior surface of the sensor 424 without the sensor cleaning system having been activated for the sensors 424.

According to embodiments, the vehicle 101 may include a sensor clearing and/or cleaning activation (SCCA) 430 to cause the sensor clearing system 316a and/or the sensor cleaning system 450 to be activated for the sensor unit 316. The SCCA 430 may be configured to determine, based on the sensor data generated by the senor 424 and/or the precipitation sensor 316b, whether to activate the sensor cleaning system for sensor 424, the sensor clearing system 316a for sensor 424, or both.

In one aspect, duct assembly 452b may be configured to effectively provide one or more ducts through which air exiting fan arrangement 452a may flow. Duct assembly 452b (which may be alternatively referred to as a duct arrangement, a duct subassembly, or a sensor mount) may include ducts, or paths, through which air may flow such that an air flow, e.g., an air curtain, may flow over a surface of sensor 424. In one embodiment, duct arrangement 452b may cooperate with at least one surface of sensor 424 to create a duct or nozzle arrangement. The one or more ducts created by duct arrangement 452b may alter the velocity and/or pressure of air flowing therethrough. The orientation and configuration of ducts may be selected such that the velocity of air or gas that exits the ducts may be at a desired level, e.g., may be relatively high.

In another aspect, duct assembly 452b may attach to the fan arrangement 452a and to the sensor 424. For instance, the duct assembly 452b may include one or more mounting holes (or other means of attachment) for attaching to the sensor 424 and may further include one or more mounting holes (or other means of attachment) for attaching to the fan arrangement 452a. In this manner, the sensor unit 316 may be assembled using the duct assembly as points of attachment for both the sensor 424 and the fan arrangement 452a. In yet another aspect, the duct assembly 452b may further be used to attach the sensor unit 316 to the autonomous vehicle 101. For example, the duct assembly 452b may further include one or more mounting holes (or other means of attachment) for attaching the duct assembly 452b (and thus the sensor unit 316) to the body of the autonomous vehicle 101 or another component of the autonomous vehicle 101. In certain examples, the duct assembly 452b may be used to attach the sensor unit 316 to a sensor assembly or a sensor pod that houses a plurality of sensors in addition to sensor 424. And the sensor assembly may be mounted on top of the autonomous vehicle 101.

According to embodiments, the sensor unit 316 and the duct assembly 452b may be configured and/or arranged differently depending on the sensor 424. In one example, for a long-range LiDAR of the autonomous vehicle 101 to be mounted atop the autonomous vehicle 101, sensor unit 316 may be configured such that fan arrangement 452a is attached below the duct assembly 452b, which in turn is attached below the sensor 424. The air flow generated by the fan arrangement 452a may be directed upwards by the duct(s) of the duct assembly 452b to create an air curtain for clearing the sensor 424. In another example, for a short-range LiDAR of the autonomous vehicle to be mounted on the side or in the front of the autonomous vehicle, the duct of the duct assembly 452b may direct air flow generated by the fan arrangement 452a downwards to create an air curtain for clearing the sensor 424. As used herein, the vertical direction (e.g., upwards, downwards, above, below, X-Y-Z coordinates, etc.) may be relative to the orientation of the autonomous vehicle.

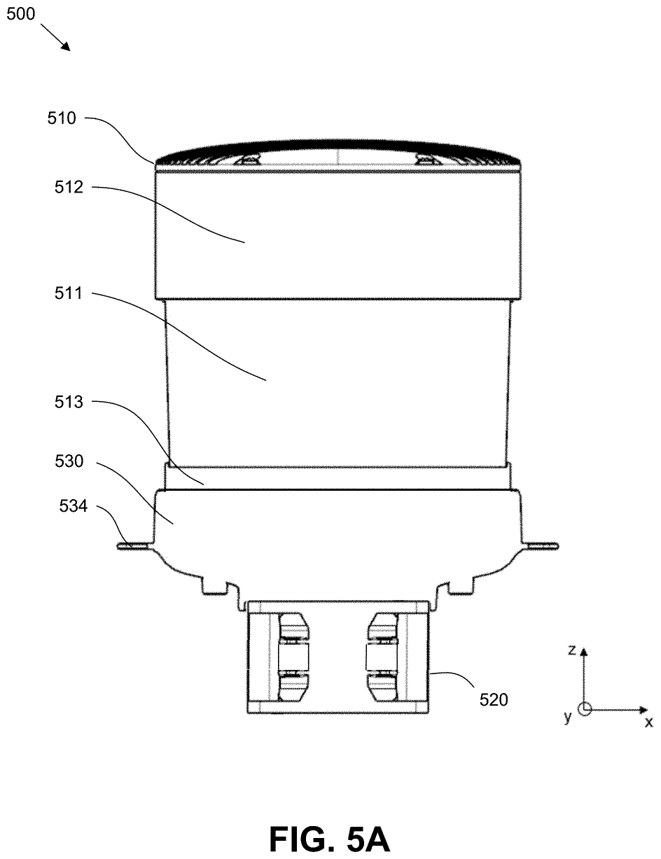

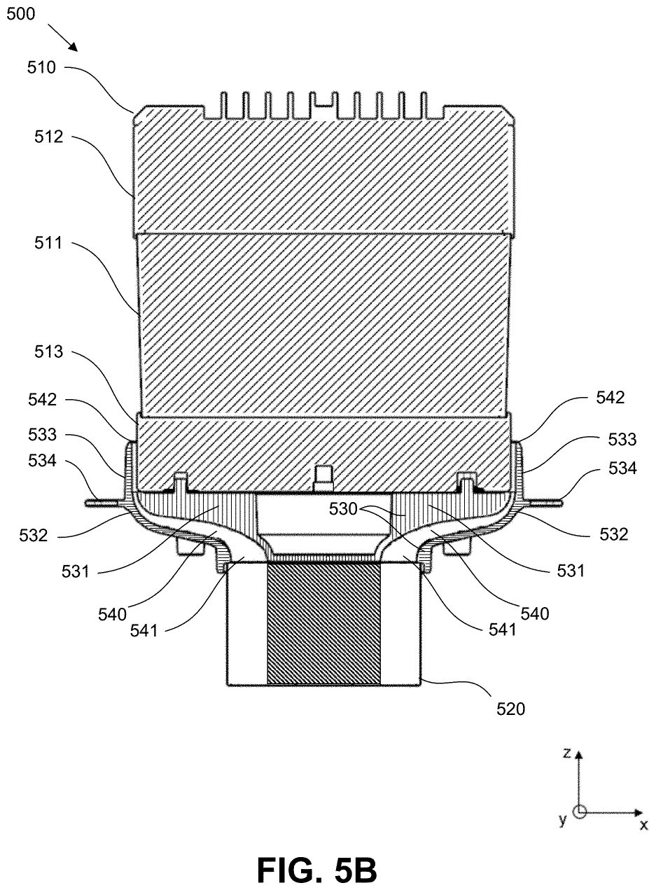

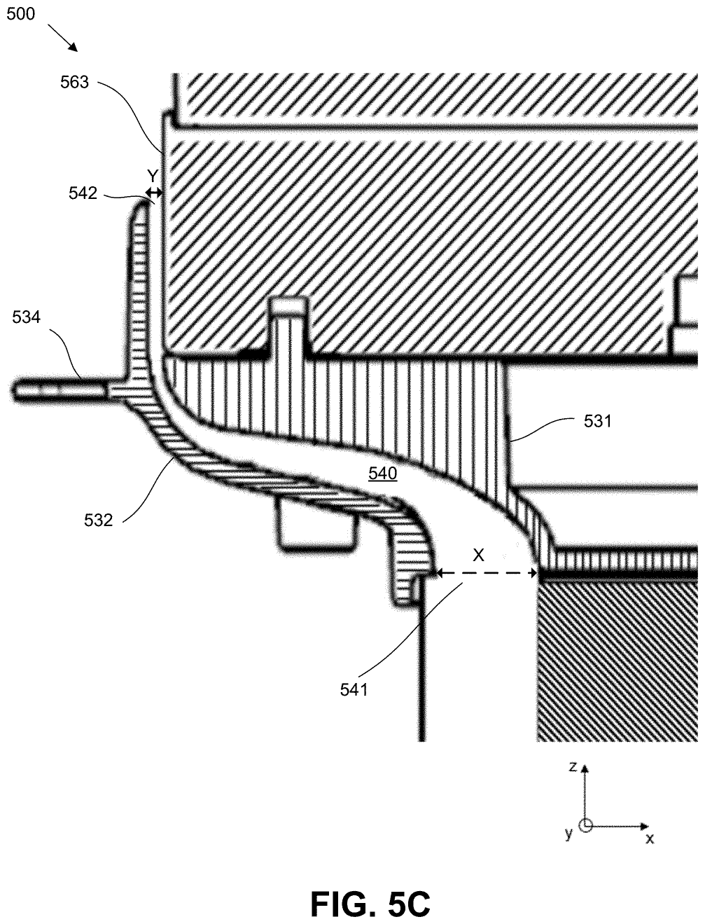

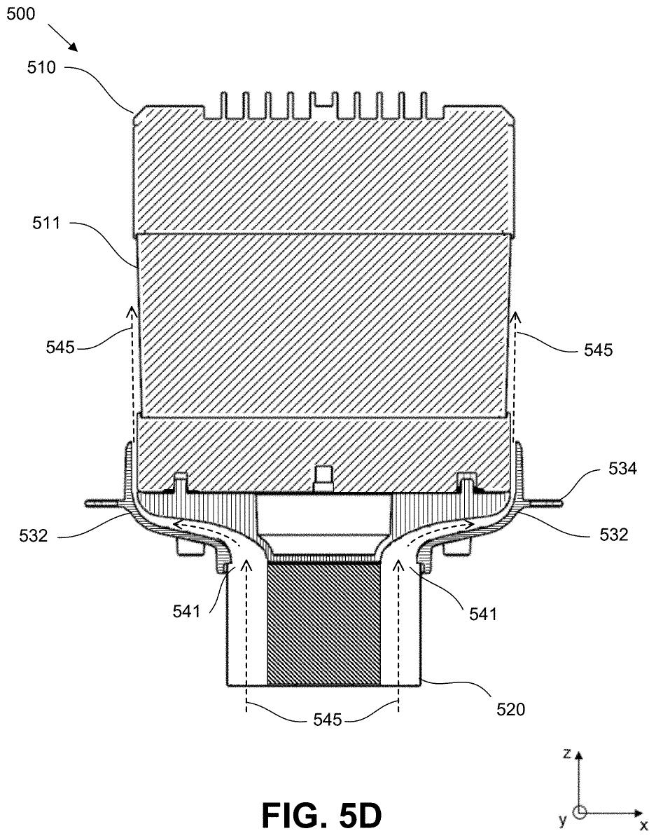

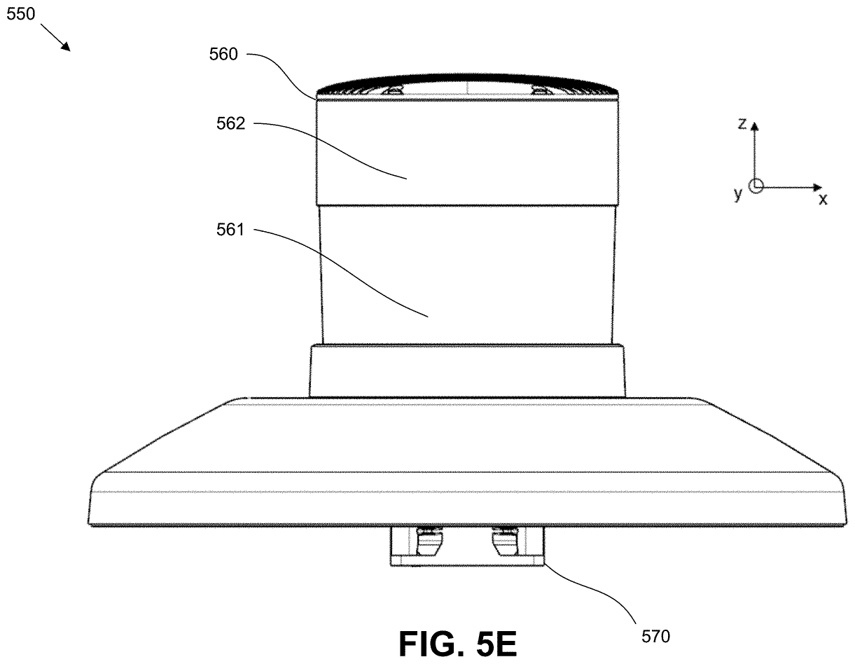

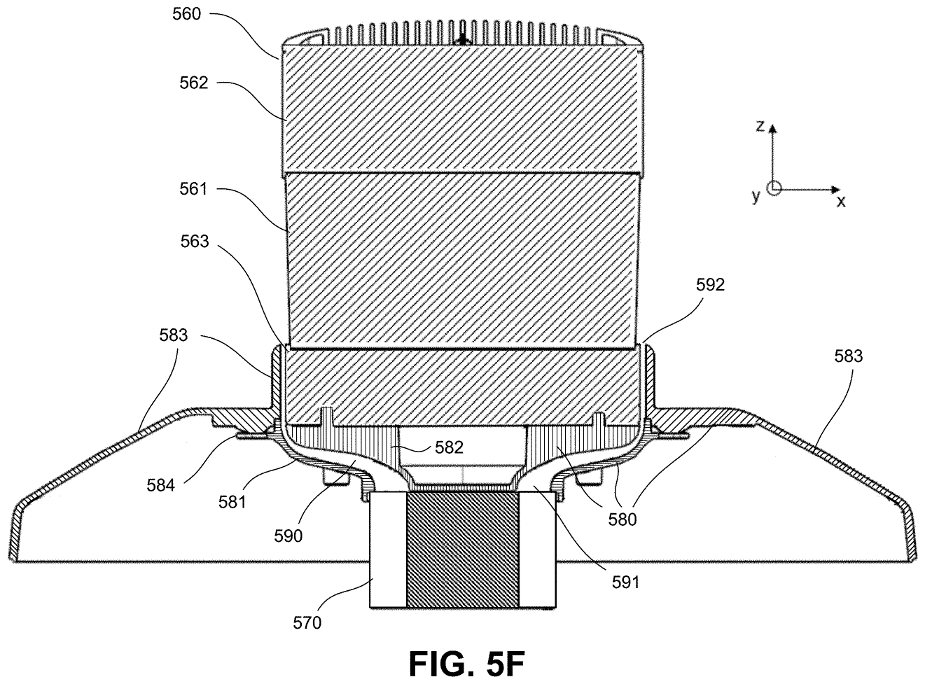

FIGS. 5A-D illustrate an example of a sensor unit, e.g., sensor unit 316 of FIGS. 3 and 4, in accordance with embodiments. More specifically, FIG. 5A illustrates an elevation view or a side view of an example of the sensor unit, FIG. 5B is a diagrammatic cross-sectional representation of the sensor unit, FIG. 5C illustrates an enlarged portion of FIG. 5B for illustrative purposes, and FIG. 5D is a diagrammatic cross-sectional representation of the sensor unit which further illustrates an airflow, in accordance with embodiments.

Sensor unit 500 depicted in FIGS. 5A-D includes a sensor 510 which, as shown, may be a lidar unit. Sensor unit also includes a fan 520 and duct assembly 530 (which may also be referred to as a duct arrangement, a duct subassembly, or a sensor mount). Fan 520 may be an example of fan arrangement 452a of FIG. 4 and the duct assembly 530 may be an example of duct assembly 452b of FIG. 4. Fan 520 may be mounted substantially beneath duct arrangement 530 such that air may flow in a positive z-direction from the fan 520 through duct arrangement 530 and substantially around or across an exterior surface of sensor 510.

In particular, the duct assembly 530 may comprise two separable pieces 531 and 532. The first 531 of the two separable pieces may be suitable for attaching to the sensor 510 and the second 532 of the two separable pieces may be suitable for attaching to the fan arrangement 520. The duct assembly 530 may be circular in shape (e.g., when viewed from a top-down perspective). And the first piece 531 and the second piece 532 may each be circular in shape when viewed from the top-down perspective. In particular, the first piece 531 suitable for attaching to the sensor 510 may be smaller in diameter than the second piece 532. As can be seen in the cross-sectional representation depicted in FIG. 5B, the first piece 531 may be an inner piece of the duct assembly 530 and the second piece 532 may be an outer piece of the duct assembly 530. In addition, when the first piece 531 is attached to the second piece 532 to form the duct assembly 530, the first and second pieces 531 and 532 may be concentric to one another (e.g., when viewed from above or from a top-down perspective).

According to embodiments, the pieces 531 and 532, when assembled into the sensor assembly 530, form at least a first portion of a duct 540 for directing air from the fan towards the sensor 510. More specifically, the first portion of the duct 540 may be formed as a cavity or space between a surface of the first piece 531 of the duct assembly 530 and a surface of the second piece 532 of the duct assembly 530. A second portion of the duct 540 may be formed between the second piece 532 of the duct assembly 530 and the sensor 510, when the sensor 510 is attached to the duct assembly 530. More specifically, the second portion of the duct 540 may be formed as a space between a surface of the sensor 510 and a surface of the second piece 532 of the duct assembly 530. Thus, the duct 540 that is arranged to direct air from the fan 520 towards a sensor window of the sensor 510 may at least be partially formed between the duct assembly 530 (e.g., the second piece 532) and the sensor 510.

In more detail, a first opening 541 (e.g., an airflow intake) of the duct 540 may be part of the first portion of the duct 540 that is formed between the two separable pieces 531 and 532 and a second opening 542 (e.g., an airflow exhaust) of the duct 540 may be part of the second portion of the duct 540 that is formed between the second piece 532 and the sensor 510. Accordingly, the first opening 541 may correspond to a gap between the two separable pieces 531 and 532 and the second opening 542 may correspond to a gap between the second separable piece 532 and the sensor 510. The sensor unit 500 may be configured such that the airflow that is created when the fan 520 is operating enters the duct 540 at the first opening 541 and exits the duct at the second opening 542.

Depending on the implementation, the particular dimensions of the duct assembly 530 may be chosen based on the desired airflow properties (e.g., speed or shearing force of the airflow exiting the duct) and/or on the specifications of the fan 520. For example, to achieve desirable airflow properties such as airflow speed, the airflow intake (first opening 541) may be larger or wider than the airflow exhaust (second opening 542). Referring to FIG. 5C, which depicts an enlarged portion of FIG. 5B for illustrative purposes, a width of the airflow intake 541 is illustrated as “X” and a width of the airflow exhaust 542 is illustrated as “Y.” X may represent the size of a gap between the first piece 531 and the second piece 532 and Y may represent the size be a gap between the second piece 532 and a lower sensor housing surface 563 of the sensor 560. “X” may be greater than “Y” to achieve desirable airflow properties such as shear force and air speed. Depending on the implementation, the ratio of X to Y may be at least 2:1, at least 3:1, at least 4:1, at least 5:1, or at least 10:1.

Furthermore, the sensor 510 may be a cylindrical lidar and the air curtain formed by the airflow exiting the duct 540 may extend 360 degrees around the sensor 510 (e.g., extending in a 360-degree range around a vertical axis of the sensor 510). Accordingly, the first opening 541 of the duct 540, which as described above may correspond to the gap between the first piece 531 and the second piece 532, may extend 360-degrees about a vertical axis. And the second opening 542 of the duct 540, which as described above may correspond to the gap between the second piece 532 and the sensor 510, may also extend 360-degrees about the vertical axis. The common vertical axis of the first opening 541 and the second opening 542 may be defined by the cylindrical lidar (e.g., the common vertical axis may correspond to the axis of rotation of the cylindrical lidar) and/or the fan 520 (e.g., the common vertical axis may correspond to an axis of spin of the blades of the fan 520).

According to embodiments, the exterior of the sensor 510 may comprise a sensor window 511, an upper sensor housing surface 512, and a lower sensor housing surface 513. As discussed herein, the sensor 510 may be a cylindrical lidar sensor and the sensor window 511 may correspond to an area from which laser is emitted from the lidar sensor for measuring the exterior environment and/or an area through which reflected laser is received and detected. The upper sensor housing surface 512 may refer to a sensor housing surface above the sensor window 511 and the lower sensor housing surface 513 may refer to a sensor housing surface below the sensor window. The sensor unit 500, including the fan 520 and the duct assembly 530, may be configured to generate and direct an airflow to remove or clear contaminants such as debris, dust, precipitation, or moisture from at least a portion of the sensor window 511 or otherwise prevent such contaminants from accumulating or attaching to the sensor window 511.

As depicted in FIG. 5B-D, the second portion of the duct 540 (including the second opening 542 of the duct 540) may be formed between the second piece 532 of the duct assembly 530 and a lower sensor housing surface 513 of the sensor 510. Among other benefits, by utilizing a lower sensor housing surface 513 of the sensor 510 to form at least a portion of the duct 540 (e.g., to form an exhaust 542 portion of the duct 540), the resulting airflow may exit the duct 540 closer to the sensor window 511 and thereby improving various characteristics of the airflow that exits the duct 540 (e.g., an air curtain). In particular, the efficacy of the air curtain in removing or clearing contaminants from the sensor window 511 or in preventing such contaminants from accumulating on the sensor window 511 may be significantly improved.

According to embodiments, the second piece 532 of the duct assembly 530 comprises circumferential sidewall 533 that is arranged substantially vertically to direct the airflow from the fan substantially upwards towards and across the sensor window 511 of the sensor 510. In certain implementations, the circumferential sidewall 533 at the second opening 542 (e.g., airflow exhaust) where the airflow exits the duct 540 may be at an angle with respect to the lower sensor housing surface 513 (e.g., the surface of the sensor 510 that forms a portion of the duct 540) of the sensor 510. In this manner, the angle of the airflow exiting the duct 540 may be modified to achieve particular qualities (e.g., desired shearing force across the sensor window 511, etc.). In other implementations, the circumferential sidewall 533 at the second opening 542 may be substantially parallel to the lower sensor housing surface 513 of the sensor 510.

Furthermore, the edge of the circumferential sidewall 533 at the second opening 542 of the duct 540 may be a chamfered or a filleted edge. In particular, a chamfered edge may refer to a sloped or angled edge and a filleted edge may refer to a rounded edge. The particular design (e.g., a straight edge, a chamfered edge, or a filleted edge) may be chosen based on the desired airflow quality. In certain scenarios, a chamfered edge or a filleted edge at the second opening 542 where the airflow exiting the duct 540 may achieve desirable airflow qualities such as being a smooth laminar flow as the airflow exits the duct 540.

According to embodiments, the duct assembly 530, in particular the second piece 532 of the duct assembly 530, may include a mounting bracket lip 534. The mounting bracket lip 534 may be arranged substantially perpendicular to the circumferential sidewall 533 and may extend in the X-Y plane. The mounting bracket lip 534 may be used to attach the sensor unit 316 (which may include the duct arrangement, the sensor, and the fan) to the autonomous vehicle. For instance, the mounting bracket lip 532 includes mounting holes for attaching the sensor unit 500 to the body of the autonomous vehicle or to a sensor pod which in turn is attached or coupled to the autonomous vehicle.

As previously mentioned, a sensor unit such as 500 is generally configured to provide an air flow that effectively removes precipitation from, and/or prevents precipitation from contacting, a surface of a sensor. FIG. 5D is a diagrammatic cross-sectional representation of a sensor unit 500 which further illustrates airflow in accordance with an embodiment. When fan 520 of sensor unit 500 is activated, fan 520 may provide an airflow 545 through the duct assembly 530. As airflow 545 progresses through the duct assembly, the duct 540 formed by the duct assembly 530 and/or the sensor 510 (e.g., lower sensor housing surface 513) may be directed upwards towards the sensor window 511 of the sensor 510 (e.g., to form an air curtain) to clear or remove contaminants on the sensor window surface 511 and/or prevent contaminants from accumulating on the sensor window surface 511. According to embodiments, the airflow 545 may be accelerated (e.g., airflow speed may be increased) by the duct 540. For example, the airflow 545 exiting the duct 540 at the airflow exhaust 542 (e.g., the second opening 542) may have a higher or greater airflow speed than the airflow 545 entering the duct at the airflow intake 541 (e.g., the first opening 541).

FIGS. 5E-F illustrate another example of a sensor unit, e.g., sensor unit 316 of FIGS. 3 and 4, in accordance with embodiments. More specifically, FIG. 5E illustrates an elevation view or a side view of an example of the sensor unit and FIG. 5B is a diagrammatic cross-sectional representation of the sensor unit.

Sensor unit 550 depicted in FIGS. 5E-F includes a sensor 550 which, as shown, may be a lidar unit. Sensor unit also includes a fan 570 and duct assembly 580 (which may also be referred to as a duct arrangement, a duct subassembly, or a sensor mount). Fan 570 may be an example of fan arrangement 452a of FIG. 4 and the duct assembly 530 may be an example of duct assembly 452b of FIG. 4. Fan 570 may be mounted substantially beneath duct arrangement 530 such that air may flow in a positive z-direction from the fan 570 through duct arrangement 530 and substantially around or across an exterior surface of sensor 560. Except as described below, the sensor unit 550 may be similarly configured or arranged as the sensor unit 500 illustrated and described with respect to FIGS. 5A-D.

In particular, the duct assembly 550 may comprise three separable pieces 581, 582, and 583. The first 581 of the three separable pieces may be suitable for attaching to the sensor 510 and the second 582 of the three separable pieces may be suitable for attaching to the fan arrangement 520. The duct assembly 580 may be circular in shape (e.g., when viewed from above or from a top-down perspective). And the first piece 581, the second piece 582, and the third piece 583 may each be circular in shape when viewed from the top-down perspective. In particular, the first piece 581 suitable for attaching to the sensor 510 may be smaller in diameter than the second piece 582. As can be seen in the cross-sectional representation depicted in FIG. 5F, the first piece 581 may be an inner piece of the duct assembly 580 and the second piece 582 may be an outer piece of the duct assembly 580. In addition, when the first piece 581 is attached to the second piece 582 to form the duct assembly 580, the first piece 581, the second piece 582, and/or the third piece 583 may be concentric to one another (e.g., when viewed from above or from a top-down perspective).

When the sensor unit 550 is assembled, the first and second pieces 581 and 582 may form a first portion of a duct 590 for directing airflow from the fan to clear or remove contamination from a sensor window 561 of a sensor 560. The third piece 582 may form a second portion of the duct 590 with a lower sensor housing surface 563 of the sensor. More specifically, the first portion of the duct 590 may be formed as a cavity or space between a surface of the first piece 581 of the duct assembly 580 and a surface of the second piece 582 of the duct assembly 530. A second portion of the duct 590 may be formed between the third piece 582 of the duct assembly 580 and the sensor 560, when the sensor 560 is attached to the duct assembly 550. More specifically, the second portion of the duct 590 may be formed as a cavity or space between a surface of the sensor 560 and a surface of the third piece 583 of the duct assembly 580. Thus, the duct 590 that is arranged to direct air from the fan 570 towards the sensor window 561 of the sensor 560 may at least be partially formed between the duct assembly 550 (e.g., the third piece 583) and the sensor 560. In particular, the first and second pieces 581 and 582 may form an airflow intake (e.g., a first opening) 591 of a duct 590. And the third piece 583 and a lower sensor housing surface 563 may form an airflow exhaust 592 (e.g., a second opening) 592 of the duct 590.

According to embodiments, the third piece 583 of the duct assembly 580 may further function as a portion of a housing (e.g., a top cover) for a sensor assembly or a sensor pod. The sensor assembly or sensor pod may include other sensors such as radars, cameras, and the like. The sensor assembly or sensor pod may be attached or installed atop an autonomous vehicle and may provide sensor data (including from sensor 560) to enable the autonomous vehicle to navigate and operate in an autonomous or semi-autonomous manner. In the example illustrated in FIGS. 5E-F, the third piece 583 of the duct assembly 580 may form a circumferential sidewall that is arranged substantially vertically to direct the airflow from the fan substantially upwards towards and across the sensor window 511. Furthermore, the second piece 532 may include a mounting bracket lip 584 that may be used to attach or secure the second piece 532 to the third piece 583 of the duct assembly 580 (e.g., via one or more mounting holes on the mounting bracket lip).

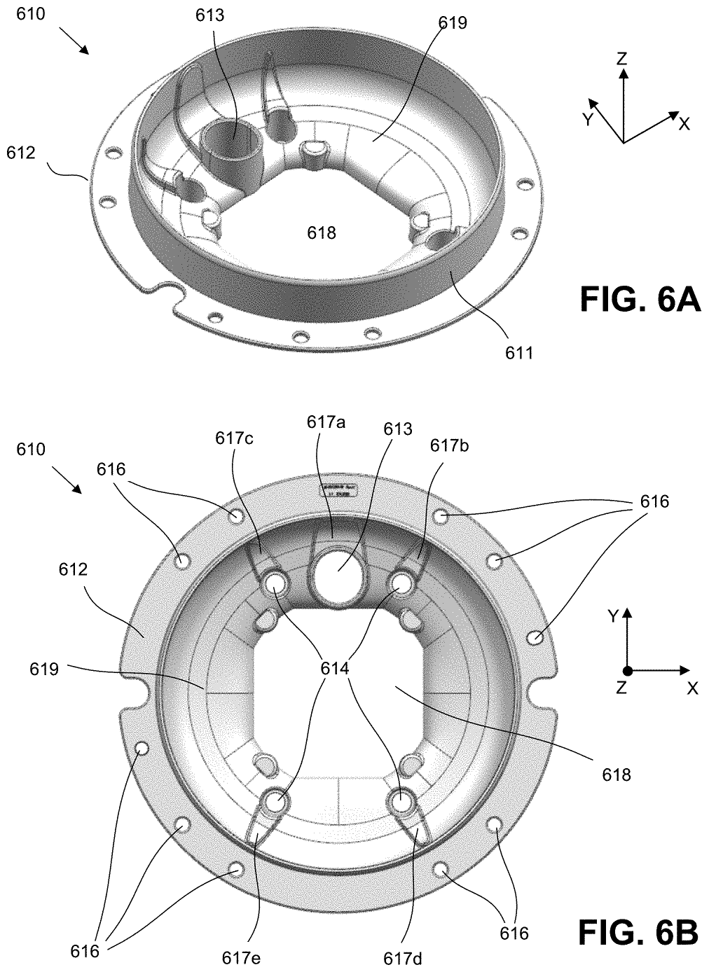

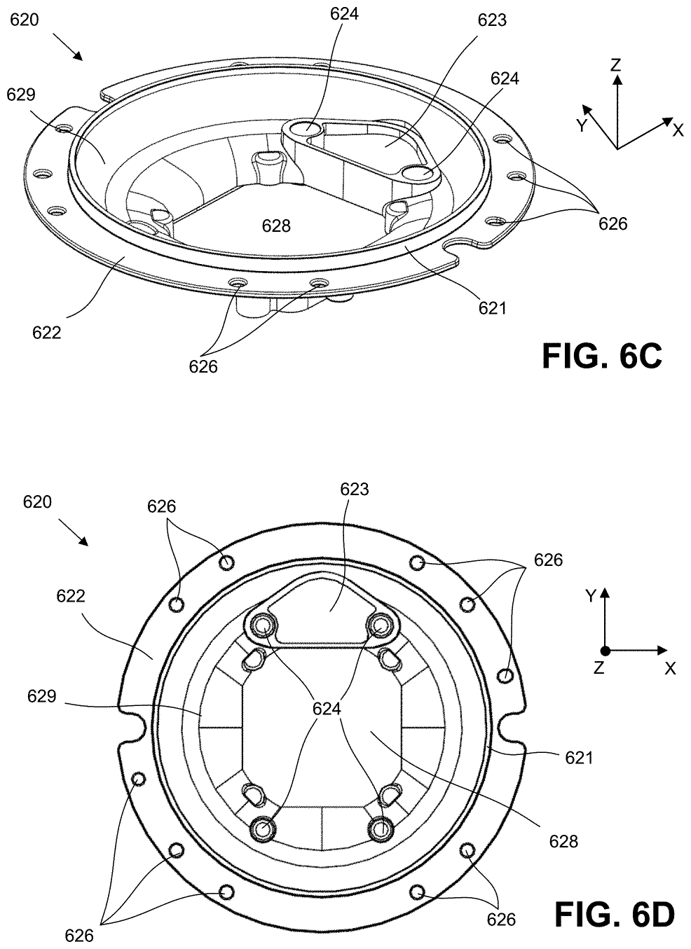

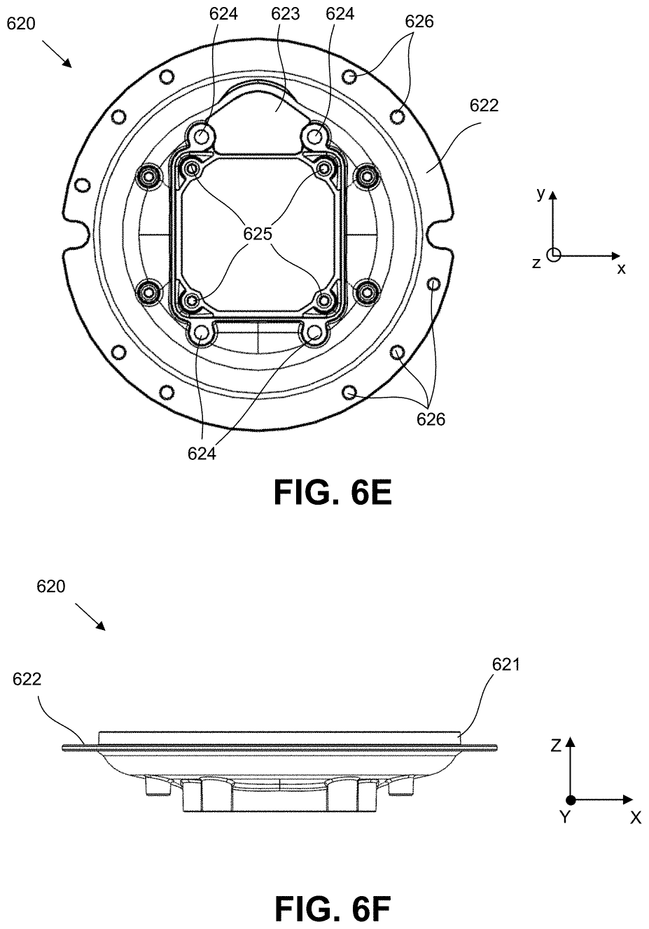

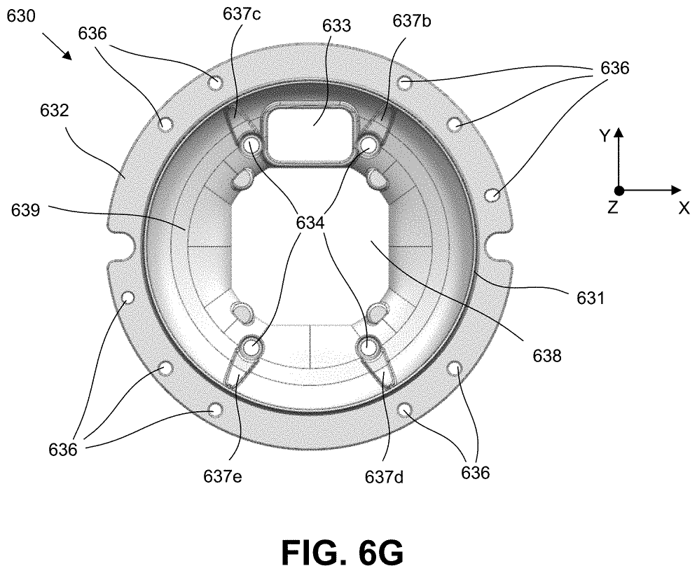

FIGS. 6A through 6G are diagrammatic representations of examples of a portion of the duct arrangement, in accordance with embodiments. In particular, FIGS. 6A through 6G may depict examples of the second piece 532 of the duct arrangement 530 illustrated in FIGS. 5A-F. FIGS. 6A through 6B illustrate a first example 610, FIGS. 6C-F illustrate a second example 620, and FIG. 6G illustrates a third example 630. As described, duct arrangement 530 of FIG. 5 generally includes features which enable the duct arrangement 530 (e.g., when attached, secured, or physically coupled to a sensor and a fan arrangement) to form one or more ducts 540 which provide airflow that removes or clears contamination such as dust, debris, or precipitation from an exterior surface (e.g., a sensor window) of the sensor, or otherwise prevents such contamination from attaching to the exterior surface of the sensor. In particular, the second piece 532 of the duct arrangement 530, examples of which are illustrated in FIGS. 6A-F, may be attached, coupled, or secured to a first piece 531 of the duct arrangement 530 to form at least a portion of the one or more ducts 540. For example, when the duct arrangement is assembled and attached to the sensor, at least a portion of the inner surface of the second piece 532, along with the first piece 531 of the duct arrangement and an exterior surface of the sensor housing, forms at least a portion the duct for directing air flow from the fan upwards towards the sensor window of the sensor to create an air curtain for removing debris, dust, contamination, or precipitation from the sensor window.

With respect to FIGS. 6A-6B, FIG. 6A illustrates a perspective or isometric view of the first example of the second piece 610 of the duct assembly and FIG. 6B illustrates a plan view (e.g., a view from above, viewing the X-Y plane from a positive Z-axis position). The second piece 610 of the duct arrangement illustrated in FIGS. 6A-B may be an example implementation of the second piece 532 of the duct assembly 530 illustrated in FIGS. 5A-D and may comprise features such as a circumferential sidewall 611, a mounting bracket lip 612, a cable passthrough 613, a first set of mounting holes 614, a second set of mounting holes (not illustrated in FIGS. 6A-B), a third set of mounting holes 616, fairings 617a-e, a fan cutout 618, and a duct-forming surface 619. The circumferential sidewall 611 (which may be an example of the circumferential sidewall 533 illustrated in FIG. 5) may extend substantially in the vertical direction (e.g., in the z-axis direction). The circumferential sidewall 611 extends 360 degrees around the center of the second piece 610. When the duct arrangement is assembled and attached to the sensor and to the fan, the inner surface of the circumferential sidewall 611 may be arranged to direct the air flow from the fan upwards towards the sensor window of the sensor. The mounting bracket lip 612 may be arranged substantially perpendicular to the circumferential sidewall 611 and may extend in the X-Y plane. The mounting bracket lip 612 may be used to attach the sensor unit 316 (which may include the duct arrangement, the sensor, and the fan) to the autonomous vehicle. For instance, the mounting bracket lip 612 includes mounting holes 616 for attaching the sensor unit 316 the body of the autonomous vehicle or to a sensor pod which in turn is attached or coupled to the autonomous vehicle. It should be appreciated that although ten mounting holes 616 are illustrated in FIGS. 6A-B, any number of mounting holes may be provided on the mounting bracket lip 612 for attaching or securing the duct assembly and the sensor unit onto the autonomous vehicle or a sensor pod that is in turn attached to the autonomous vehicle.

The cable passthrough 613 may be a structural element on the second piece 610 that enables one or more cables of the sensor (e.g., power cable, data cable, etc.) to be routed through the second piece 610 for coupling with connector(s) to enable the sensor to be powered and/or data from the sensor to be transmitted to other components on the autonomous vehicle. In the example illustrated in FIGS. 6A-6B, the cable passthrough 613 is circular and may be arranged on the duct-forming surface 619 of the second piece 610 between two of the mounting holes 624. As can be seen in FIG. 6A, the cable passthrough 613 may comprise a circular wall extending in the vertical direction. The first set of mounting holes 614 may be used to attach the second piece 610 with the first piece of the duct assembly. In other words, the first set of mounting holes 614 may be used to assemble the duct assembly. According to embodiments, the first set of mounting holes 614 may further be used to attach the sensor to the duct assembly. For example, screws that are used to attach or secure the first piece of the duct assembly to the second piece 610 may further attach to the sensor housing to attach or secure the sensor to both the first piece and second piece 610 of the duct assembly (and thereby securing the sensor to the duct assembly). The second set of mounting holes may be provided on the underside of the second piece 610 (and thus not illustrated in FIGS. 6A-B) and may be used to attach or secure the fan to the duct assembly. The fan may be attached or secured to the second piece 610 such that the fan fits within the fan cutout 618 and that the airflow generated by the fan when it is operating may be upward through at least a portion of the fan cutout 618.

The fairings 617a-e are generally structures configured to guide air flow to create a substantially laminar, or smooth, air flow. The fairings 617a-e may indentations, protrusions, attachments, and/or structures on a surface of the second piece 610 that forms (along with a surface of the first piece of the duct assembly) the duct 640 for directing the airflow from the fan. This surface of the second piece 610 of the duct assembly may be referred to herein as the duct-forming surface 619 (alternatively, the upward-facing surface or inner surface) of the second piece 610. The size, shape, and location of fairings 656a-e may be selected to achieve particular qualities in air flow, e.g., specific flow velocities, pressures, flow shape, flow shear, etc. According to embodiments, each of the fairings 617a-e may be provided to re-shape or re-direct airflow resulting from another structure or feature on the upward-facing or internal surface of the second piece 610. For instance, the presence of the cable passthrough 613 may affect the airflow through the duct 540 and the resulting air curtain. The fairing 617a may be provided on the duct-forming surface 619 to re-shape or re-direct airflow resulting from the presence of the cable passthrough 613 on the duct-forming surface 619 such that the air curtain exiting the duct achieves the aforementioned qualities or characteristics. Similarly, fairings 617b-e may be provided on the duct-forming surface 619 of the second to re-shape or re-direct airflow resulting from a corresponding one of the mounting holes 614 for attaching or securing the first piece of the duct assembly to the second piece 610. As can be seen in FIGS. 6A-B, one or more of the fairings 617a-e may extend to the circumferential sidewall 611. Although five fairings 656a-e have been shown, it should be appreciated that the number of fairings 656a-e may vary widely, e.g., there may be fewer than or more than five fairings 656a-e. Thus, in certain embodiments, no fairings may be provided for any of the structures or features on the duct-forming surface 619 of the second piece 610. In other embodiments, fairings may be provided for some but not all of the features on the duct-forming surface 619. And yet in still further embodiments, a corresponding fairing may be provided for each of the features on the duct-forming surface 619 of the second piece 610.

FIG. 6C-F illustrates the second example of the second piece 620 of the duct arrangement, in accordance with embodiments. More specifically, FIG. 6C illustrates a perspective or isometric view of the second example of the second piece 620 of the duct assembly, FIG. 6D illustrates a plan view (e.g., a view from above, viewing the X-Y plane from a positive Z-axis position), FIG. 6E illustrates a view from below (e.g., viewing the X-Y plane from a negative Z-axis position), and FIG. 6F illustrates an elevation view or a side view. The second piece 620 of the duct arrangement illustrated in FIGS. 6C-F may be an example implementation of the second piece 582 of the duct assembly 550 illustrated in FIGS. 5E-F and may comprise features such as a circumferential sidewall 621, a mounting bracket lip 622, a cable passthrough 623, a first set of mounting holes 624, a second set of mounting holes 625, a third set of mounting holes 626, a fan cutout 628, and a duct-forming surface 629. In contrast with the circumferential sidewall 611 of the first example 610 of FIGS. 6A-B, the second piece 620 of the duct assembly illustrated in FIGS. 6C-F, the circumferential sidewall 621 of the second example 620 of FIG. 6C-F may be much shorter in height (in the Z-direction) because the sensor unit 550 of FIG. 5E-F that comprises the second piece 620 may further include a third piece 583 that forms a portion of the duct (e.g., in place of a taller circumferential sidewall). Furthermore, in contrast to the cable passthrough 613 of the first example 610, the cable passthrough 623 may be triangular in shape. In particular, the cable passthrough 623 may be a rounded triangle in which a first of the mounting holes 624 is substantially positioned at a first vertex of the rounded triangle and a second of the mounting holes 624 is positioned at a second vertex of the rounded triangle. As can be seen in FIG. 6C-F, the features on the duct-forming surface 639 of the second piece 620 do not have associated with fairings. The third set of mounting holes 626 on the mounting bracket lip 622 may be used to attach the second piece 620 to a third piece (e.g., 583 of FIGS. 5E-F) of the duct assembly.

FIG. 6G illustrates the third example of the second piece 630 of the duct arrangement, in accordance with embodiments. More specifically, FIG. 6G illustrates a plan view (e.g., a view from above, viewing the X-Y plane from a positive Z-axis position) of the second piece 630 of the duct arrangement. Similar to the first example 610, the third example of the second piece 630 of the duct arrangement may comprise features such as a circumferential sidewall 631, a mounting bracket lip 632, a cable passthrough 633, a first set of mounting holes 634, a second set of mounting holes 635, a third set of mounting holes 636, fairings 637b-e, a fan cutout 638, and a duct-forming surface 639. In contrast to the cable passthrough 613 of the first example 610, the cable passthrough 633 may be rectangular in shape. In particular, the cable passthrough 633 may substantially extend from a first one of the mounting holes 634 to a second one of the mounting holes 634. Furthermore, in contrast to the first example 610, the third example of the second piece 630 of the duct arrangement does not include a fairing associated with the cable passthrough 633.

According to embodiments, and as can be seen in FIGS. 6A-G, the cable passthrough arranged on the second piece of the duct arrangement may take on any shape or form. In particular, simulations of airflow qualities may be performed to determine the optimal shape, size, and location of the cable passthrough. Similarly, simulations of airflow qualities may be performed to determine whether fairings are to be provided for any of the features of the duct-forming surface of the second piece and if fairings are to be provided, the simulations may further inform as to the shape, size, and/or other characteristics of the fairings.

Although not illustrated in FIGS. 6A-G, one or more gasket(s) may be arranged or installed, for example, in between the first and second pieces of the duct assembly in areas where the two pieces come into contact. The gaskets may be installed, for example, around the cable passthrough or around the mounting holes. The gaskets may prevent air leakage from the duct and improve efficacy of the clearing mechanism of the sensor unit.

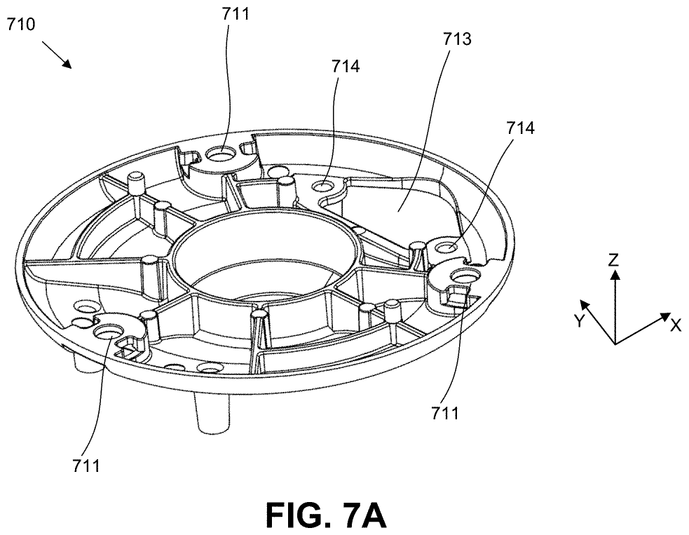

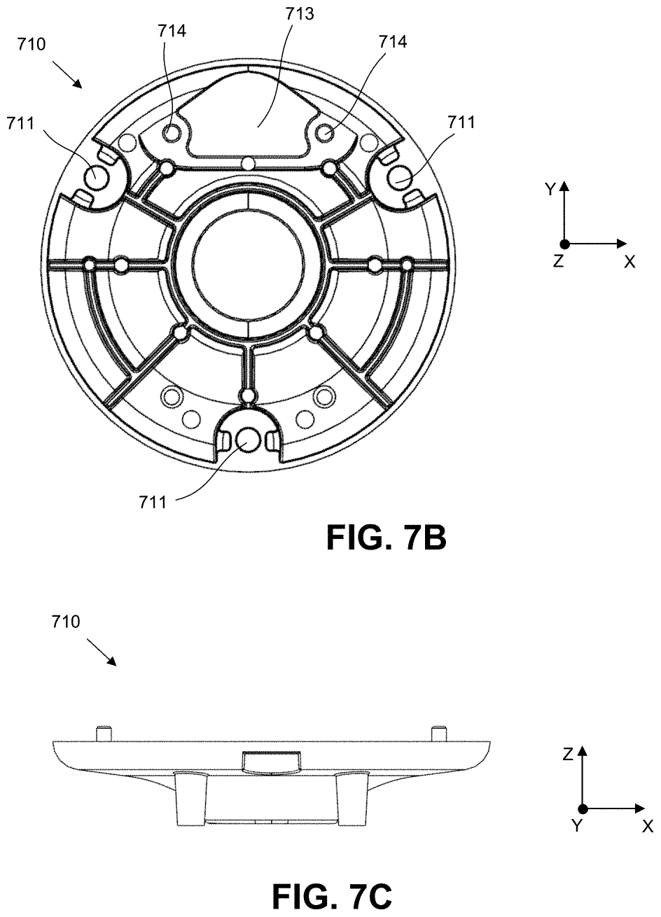

FIG. 7A-C are diagrammatic representations of an example of another portion of the duct assembly, in accordance with embodiments. In particular, FIGS. 7A-C may depict examples of the first piece 531 of the duct assembly 530 illustrated in FIGS. 5A-F. More specifically, FIG. 7A illustrates a perspective or isometric view of an example of the first piece 710 of the duct assembly, FIG. 7B illustrates a plan view (e.g., a view from above, viewing the X-Y plane from a positive Z-axis position), and FIG. 7C illustrates an elevation view or a side view. The first piece 710 of the duct assembly comprises a set of mounting holes for attaching to the sensor, a cable passthrough 713, and another set of mounting holes for attaching to the second piece of the duct assembly. The example illustrated in FIGS. 7A-C includes a triangular-shaped cable passthrough 713 but any other shape may be selected as described with respect to FIGS. 6A-G. According to embodiments, the cable passthroughs of the first piece and the second piece of the duct assembly may have the same shape.

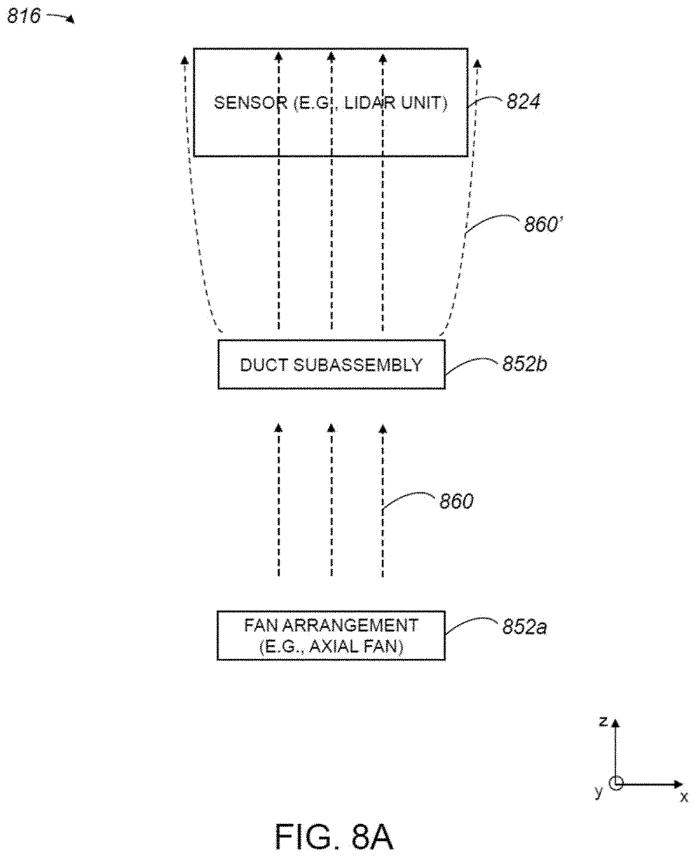

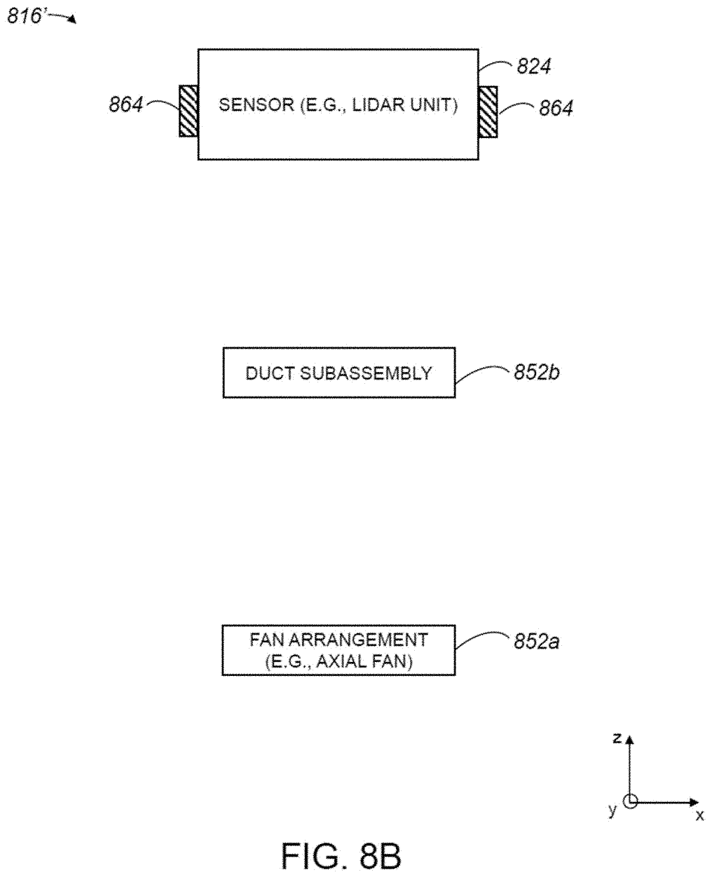

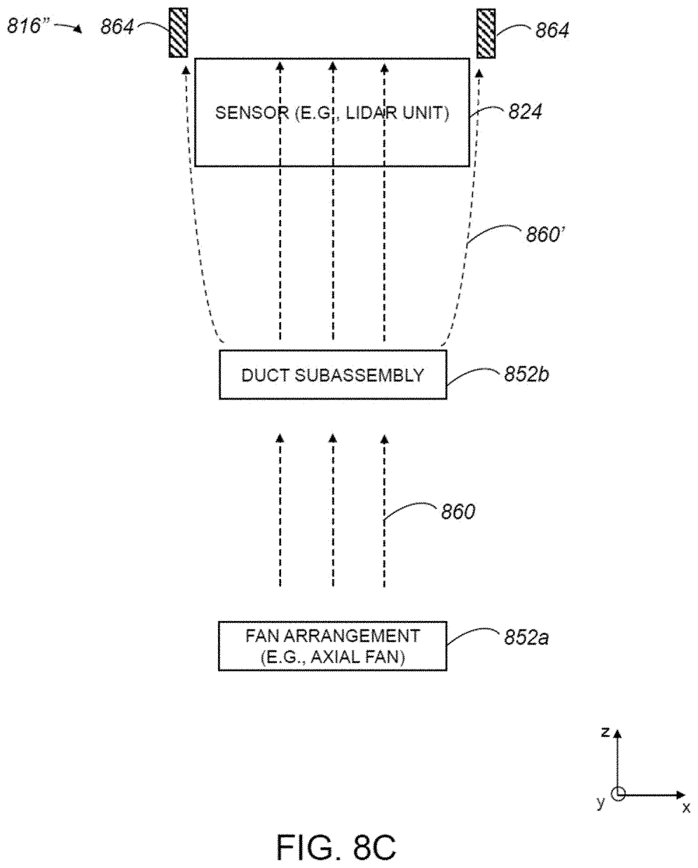

FIG. 8A is a diagrammatic representation of a sensor unit with a duct assembly which cooperates with a fan arrangement to guide air flow over a surface of a sensor in accordance with an embodiment. A sensor unit 816 includes a sensor 824, which may be a lidar unit, a fan arrangement 852a, and a duct assembly 852b (which may also be referred to as a duct arrangement or a duct subassembly). For ease of illustration, sensor 824, fan arrangement 852a, and duct assembly 852b are show as being spaced apart, although it should be appreciated that sensor 824 and/or fan arrangement 852a are generally coupled, attached, or secured to duct assembly 852b.

When activated, fan arrangement 852, which may include one or more axial fans, is configured to cause air flow 860 to flow through ducts formed at least in part by duct assembly 852b. Air flow 860′ flows out of duct subassembly 852b and over surfaces of sensor 824. Air flow 860′ may contact surfaces of sensor 824 and/or may flow over the surface. That is, air flow 860′ may flow on a surface of sensor 824 and/or along the surface of sensor 824.

FIG. 8B is a diagrammatic representation of a sensor unit 816 at a time t1 when precipitation is sensed on a surface of a sensor, and fan arrangement 852a is not activated, in accordance with an embodiment. At a time t1, sensor unit 816′ is subjected to precipitation or moisture, and surface contaminant 864 such as water droplets is present on surfaces of sensor 824. The presence of surface contaminant 864 on sensor 824 or, more generally, the presence of precipitation in an environment around sensor unit 816 may be sensed at a time t1, and a determination may be made to activate fan arrangement 852a to effectively remove the precipitation or moisture (e.g., surface contaminant 864) from sensor 824.

According to embodiments, surface contaminant 864 is not limited to precipitation or moisture. Surface contaminant 864 may refer to any contaminant that, when present on a surface of the sensor 824 (e.g., on the exterior surface of the sensor window), may cause inaccuracies in the sensor data generated by the sensor 824. Without limitation, surface contaminant 864 may include precipitation, moisture, dust, debris, stain, and the like. Specifically in the case of a LiDAR, the presence of surface contaminant 824 on the sensor window may cause scattering of laser beams used to measure distances to objects in the environment of the sensor 824 and the autonomous vehicle.

FIG. 8C is a diagrammatic representation of sensor unit 816′ at a time t2 when precipitation or surface contaminant is removed from a surface of a sensor in accordance with an embodiment. At a time t2, air flow 860 that is substantially outputted by fan arrangement 852a is provided through duct assembly 852b. The airflow 860′ may exit the duct formed at least in part by the duct assembly 852b as an air curtain for the sensor 824. Air flow 860′ is provided by duct assembly 852b to a surface of sensor 824 and essentially removes surface contaminant 864 from the surface of sensor 824. In other words, air flow 860′ applies an air velocity and/or a force to surface contaminant 864 that substantially blows surface contaminant 864 off of sensor 824.

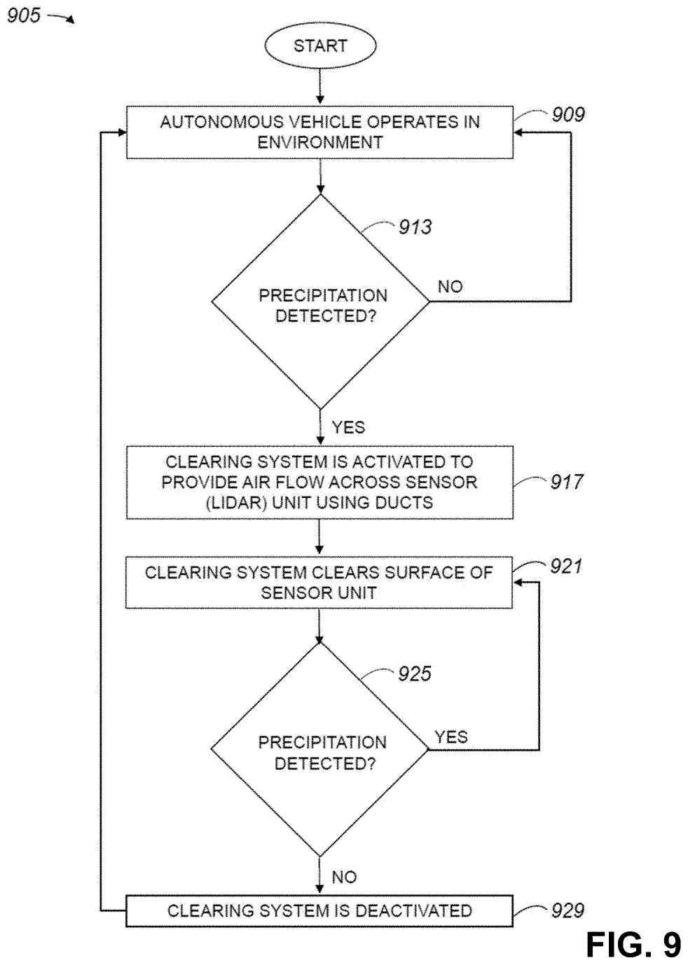

FIG. 9 is a process flow diagram which illustrates a method of clearing a surface of a sensor in accordance with an embodiment. A method 905 of clearing a surface of a sensor, e.g., a lidar unit, begins at a step 909 in which an autonomous vehicle operates in an environment. The environment may be any suitable environment including, but not limited to including, an outdoor environment, an open road environment, a closed road environment, and/or any environment which may be subject to conditions such as precipitation.

In a step 913, a determination is made as to whether precipitation is detected. Such a determination may be based upon whether a precipitation sensor senses the presence of precipitation. If the determination is that there is no precipitation detected, then process flow returns to step 909 in which the autonomous vehicle continues to operate.

Alternatively, if it is determined in step 913 that precipitation has been detected, then in a step 917, a clearing system is activated to provided air flow across a sensor unit using a duct subassembly in cooperation with a fan arrangement. Once activate, the clearing system clears a surface of the sensor unit in a step 921. Clearing the surface of the sensor unit may generally include providing an air flow that effectively blows precipitation off of the surface.

In a step 925, it is determined whether precipitation is still detected. That is, after the clearing system has been active for a particular amount of time, a determination is made as to whether precipitation is ongoing or whether precipitation has ceased. If the determination is that precipitation is still detected, the process flow returns to step 925 in which the clearing system continues to clear the surface of the sensor unit.

On the other hand, if the determination in step 925 is that precipitation is no longer detected, the implication is that the clearing system no longer needs to clear the surface of the sensor unit. As such, process flow moves from step 925 to a step 929 in which the clearing system is deactivated. Once the clearing system is deactivated, process flow returns to step 909 in which the autonomous vehicle continues to operate.

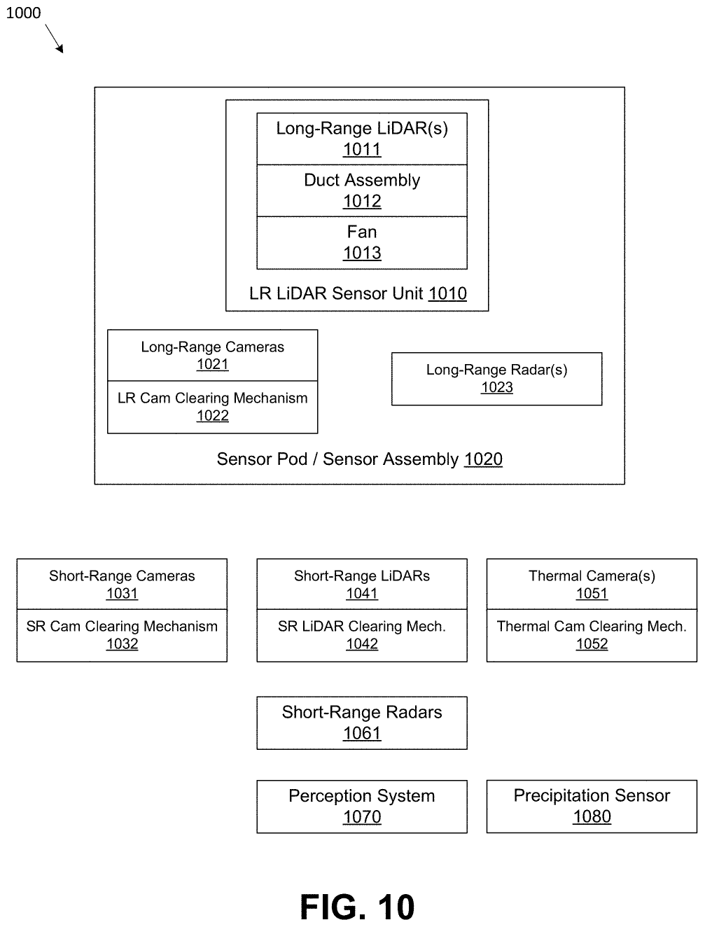

FIG. 10 is block diagram representation of sensor clearing systems of an autonomous vehicle, in accordance with embodiments. The autonomous vehicle 1000 illustrated in FIG. 10 may be an embodiment of the autonomous vehicle described in this disclosure, such as autonomous vehicle 101 of FIG. 1 to FIG. 3.

According to embodiments, the autonomous vehicle 1000 comprises various sensors including one or more long-range LiDAR(s) 1011, a plurality of long-range cameras 1021, one or more long-range radar(s) 1023, a plurality of short-range cameras 1031, a plurality of short-range LiDARs 1041, one or more thermal camera(s) 1051, and a plurality of short-range radars 1061. It should be appreciated that the sensors illustrated in FIG. 10 is not meant to be exhaustive. For example, the autonomous vehicle 1000 may, in place of one or more of the sensors illustrated in FIG. 10 or in addition to those illustrated in FIG. 10, comprise other sensors such as ultrasonic sensors, acoustic sensors, traffic light cameras, etc.

As illustrated in FIG. 10, some of the sensors may be installed on the autonomous vehicle as part of a sensor pod or sensor assembly 1020. For example, the long-range LiDAR 1011, long-range cameras 1021, and the long-rang radar 1023 (which may form a long-range LiDAR sensor unit 1010) may be part of the sensor pod 1020, which may in turn be installed on top of the autonomous vehicle 1020. The thermal cameras 1051 may also be installed on top of the vehicle. In certain implementations, the thermal cameras 1051 may be installed apart from the sensor pod 1020. For instance, the thermal cameras 1051 may be installed on a structure (e.g., an arch or a sensor arch) on which the sensor pod 1020 is attached or installed. Other sensors, such as the short-range cameras 1031, the short-range LiDARs 1041, and short-range radars 1061 may be positioned at various locations on the body of the autonomous vehicle 1000 to reduce blind spots of the sensor suite. For instance, short-range cameras 1031, short-range LiDARs 1041, and short-range radars 1061 may be positioned at the front, sides, and back of the autonomous vehicle 1000 to ensure sensor coverage for each of those areas of the autonomous vehicle.

The autonomous vehicle 1000 may further comprise a perception system 1070 to analyze the sensor data generated by each of the various sensors to generate a wholistic view or representation of the various objects, agents, obstacles, and driving surfaces in the environment of the autonomous vehicle 1000. Using the output generated by the perception system 1070, the autonomous vehicle 1000 may be able to determine a safe path to traverse or navigate its environment.

At least some of the sensors of the autonomous vehicle 1000 include clearing mechanisms to clear contaminants from the surfaces of the sensors. The sensor pod 1020, for example, may comprise a duct assembly 1012 and a fan 1013 for clearing contaminants from the long-range LiDAR 1011. The duct assembly 1012 and fan 1013 may be examples of the duct assembly and fan discussed in this disclosure, such as duct assembly 530 and fan 520 of FIGS. 5A-D. In particular, the duct assembly 1012 and fan 1013 may cooperate to generate an upward airflow or air curtain to remove contaminants from the sensor window of the long-range LiDAR 1011 as, for example, described herein. The sensor pod 1020 may further include a clearing mechanism 1022 for the long-range cameras 1021. According to embodiments, the long-range camera clearing mechanism 1022 may comprise a centrifuge configured to rotate, spin, or pivot to remove surface contaminants such as precipitation, moisture, or dust from the window of long-range cameras 1021.

According to embodiments, the sensors that are not included in the sensor pod 1020 may have individual clearing mechanisms to clear debris from those sensors. For instance, each of the short-range LiDARs 1041 may be associated with a short-range LiDAR clearing mechanism 1042. The short-range LiDAR clearing mechanism 1041 may provide an airflow via a fan and a duct. According to embodiments, the short-range LiDAR clearing mechanism 1042 may be distinct or different from the clearing mechanism for the long-range LiDAR 1011 (e.g., the duct assembly 1012 and fan 1013). For example, the short-range LiDAR clearing mechanism 1042 may provide an airflow that is downward (rather than an upward airflow or air curtain as in the case of the duct assembly 1012 and fan 1013) relative to the disposition of the short-range LiDAR 1041. Furthermore, while the airflow provided by the duct assembly 1012 and fan 103 for clearing the surface of the long-range LiDAR 1011 may extend a full 360 degrees around the long-range LiDAR 1011. In contrast, the airflow provided by the short-range LiDAR clearing mechanisms 1042 may not fully extend around the short-range LiDARs 1041. For example, the airflow provided by the short-range LiDAR clearing mechanisms 1042 may extend 90 degrees, 180 degrees, or 270 degrees around the short-range LiDARs 1041. Furthermore, the thermal cameras 1051 may have a thermal camera clearing mechanism 1052, which may comprise a fan and a duct to generate an airflow over the camera windows of the thermal cameras 1051 to clear precipitation or debris. Similarly, each of the short-range cameras 1031 may be associated with a corresponding short-range camera clearing mechanism 1032 which may similarly comprise a fan and a duct to generate airflow over the camera windows of the short-range cameras 1031 to clear the precipitation or debris.

According to embodiments, the perception system 1070 may be configured to determine whether any or all of the sensors that have associated clearing mechanisms require sensor clearing. This may be performed using sensor data generated by the sensors. In certain scenarios, the sensor clearing mechanisms of sensors may be individually activated to clear contamination present only on the affected sensors. In other scenarios (e.g., in the presence of precipitation such as detected by precipitation sensor 1080, or when all sensors appear to be contaminated), the perception system 1070 may cause all of the sensor clearing mechanisms to be activated.

Although only a few embodiments have been described in this disclosure, it should be understood that the disclosure may be embodied in many other specific forms without departing from the spirit or the scope of the present disclosure. An air flow arrangement included in a sensor unit of an autonomous vehicle may generally be controlled onboard the autonomous vehicle. In other words, a fan arrangement which provides an air flow to a duct subassembly may be activated and deactivated by an autonomous vehicle. However, it should be appreciated that the air flow may instead be controlled remotely, as for example by a fleet management module of an overall platform that includes the autonomous vehicle.

A precipitation sensor may be positioned substantially anywhere on an autonomous vehicle. By way of example, a precipitation sensor may be positioned in the vicinity of a sensor which is to be protected by an air curtain. A precipitation sensor may be an optional component of a sensor unit that includes a fan arrangement and a duct arrangement. For instance, a precipitation sensor may not be necessary if an air flow is substantially always to be provided, or if an air flow is substantially automatically provided if a weather report indicates that the chance of precipitation is above a predetermined threshold.

The use of a duct subassembly has been described as substantially directing air flow over a surface of a sensor. The ducts may generally be used to substantially control air velocity and/or air pressure. For example, the shape of the ducts, the cross-sectional area of the ducts, and/or the diameter of the ducts may be selected to provide a particular air velocity of air pressure.

An air curtain has generally been described as blowing air over a sensor at least in a positive or upward direction along a z-axis. That is, a fan arrangement has been described as being positioned substantially beneath a sensor that is to be cleared using air flow that substantially originates with a fan. It should be understood, however, that a fan arrangement may instead be positioned above a sensor such that airflow occurs at least in a negative direction along a z-axis.

It should be appreciated that the fan selected for use as part of a sensor clearing system may be selected based upon factors including, but not limited to including, the speed at which fan blades included in the fan may spin. While the use of an axial fan has been described, other types of fans or air blowers may instead be implemented.

A mount subassembly may be configured to support a sensor such as a lidar unit. A fan arrangement may be coupled to a duct subassembly, with the duct subassembly configured to substantially wrap around the mount subassembly such that the mount subassembly and the duct subassembly may effectively cooperate to form duct that direct air flow towards the sensor.

Any suitable coupling mechanism may be used to secure the various components of an overall sensor unit. For example, screws or other mechanical fasteners may be used to couple a sensor to a mount, and a fan arrangement to a duct subassembly.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A sensor unit comprising:
a fan;
a sensor having a sensor window;
a duct assembly to which the sensor and the fan are attached; and
wherein a duct that is arranged to direct air from the fan towards the sensor window is at least partially formed between the duct assembly and the sensor.

2. The sensor unit of claim 1, wherein an airflow is generated when the fan is operating and the duct is positioned to direct the airflow towards the sensor window to create an air curtain across the sensor window.

3. The sensor unit of claim 2, wherein the sensor is a cylindrical LiDAR and the air curtain extends 360 degrees around an axis defined by the cylindrical LiDAR.

4. The sensor unit of claim 1, wherein the duct assembly comprises at least two separable pieces including a first piece for attaching to the sensor a second piece for attaching to the fan.

5. The sensor unit of claim 4, wherein a first portion of the duct is formed between the first and second pieces of the duct assembly and a second portion of the duct assembly is formed between the second piece of the duct assembly and the sensor.

6. The sensor unit of claim 4, wherein a first opening of the duct is a gap between the first and second pieces of the duct assembly and a second opening of the duct is a gap between the second piece of the duct assembly and the sensor.

7. The sensor unit of claim 6, wherein an airflow created when the fan is operating enters the duct at the first opening and exits the duct at the second opening.

8. The sensor unit of claim 6, wherein the first opening of the duct and the second opening of the duct each extends 360 degrees about a common axis.

9. The sensor unit of claim 6, where the second piece of the duct assembly includes (i) a first set of mounting holes for attaching to the fan, and (ii) a second set of mounting holes for attaching to the first piece of the duct assembly and to the sensor.

10. The sensor unit of claim 4, wherein the duct assembly comprises a third piece.

11. The sensor unit of claim 4, wherein the third piece of the duct assembly forms at least a portion of a housing for a sensor assembly that includes one or more other sensors.

12. The sensor unit of claim 10, wherein a first opening of the duct is a gap between the first and second pieces of the duct assembly and a second opening of the duct is a gap between the third piece of the duct assembly and the sensor.

13. The sensor unit of claim 12, wherein an airflow created when the fan is operating enters the duct at the first opening and exits the duct at the second opening.

14. The sensor unit of claim 1, wherein the duct assembly comprises one or more mounting holes and one or more fairings associated with the one or more mounting holes.

15. The sensor unit of claim 1, wherein the duct assembly includes a cable passthrough for a cable of the sensor.

16. The sensor unit of claim 15, wherein the cable passthrough is a circle.

17. The sensor unit of claim 15, wherein the cable passthrough is a rectangle.

18. The sensor unit of claim 15, wherein the cable passthrough is a triangle.

19. The sensor unit of claim 15, wherein the cable passthrough is a rounded triangle and wherein a first mounting hole is positioned at a first vertex of the rounded triangle and a second mounting hole is positioned at a second vertex of the rounded triangle.

20. The sensor unit of claim 1, wherein the sensor unit is mounted on an autonomous vehicle and the duct directs an airflow upwards relative to the orientation of the autonomous vehicle, the airflow being generated by the fan when the fan is operating.

21. The sensor unit of claim 1, wherein the sensor unit is mounted on an autonomous vehicle via the duct assembly.

22. A sensor mount comprising:
at least two separable pieces including a first piece that is suitable for attaching to a sensor and a second piece that is suitable for attaching to a fan;
wherein the first and second pieces of the sensor mount, when assembled, form a first portion of a duct for directing air from the fan towards the sensor; and
wherein, when the sensor is attached to the sensor mount, the sensor and the sensor mount form a second portion of the duct.

23. The sensor mount of claim 22, wherein a first opening of the duct is adjacent to the fan when the fan is attached to the sensor mount and wherein the first opening of the duct is a gap between the first and second pieces of the sensor mount.

24. The sensor mount of claim 23, wherein an airflow that is generated by the fan when the fan is operating enters the duct at the first opening of the duct and exits the duct at a second opening of the duct and wherein the second opening of the duct is a gap between a third piece of the sensor mount and the sensor.

25. The sensor mount of claim 22, where the second piece of the sensor mount includes (i) a first set of mounting holes for attaching to the fan, and (ii) a second set of mounting holes for attaching to the first piece of the sensor mount.

26. The sensor unit of claim 22, wherein the first and second pieces each includes a cable passthrough for a cable of the sensor.

27. The sensor mount of claim 26, wherein the cable passthroughs of the first and second pieces are circular in shape.

28. The sensor mount of claim 26, wherein the cable passthroughs of the first and second pieces are rectangular in shape.

29. The sensor unit of claim 26, wherein the cable passthroughs of the first and second pieces are triangular in shape.

30. The sensor unit of claim 26, wherein the cable passthroughs of the first and second pieces are a rounded triangle and wherein a first mounting hole is positioned at a first vertex of the rounded triangle and a second mounting hole is positioned at a second vertex of the rounded triangle.

31. An autonomous vehicle comprising:
a sensor unit that includes a sensor having a sensor window, a fan, and a duct assembly to which the sensor and the fan are attached;
a perception system configured to receive sensor data from the sensor and other sensors onboard the autonomous vehicle; and
wherein a duct that is arranged to direct air from the fan towards the sensor window is at least partially formed between the duct assembly and the sensor.

32. The autonomous vehicle of claim 31, wherein the fan is activated in response to the perception system determining, based on the received sensor data, that the sensor window is contaminated.

33. The autonomous vehicle of claim 32, wherein the fan is activated after fluid is provided onto the sensor window by a cleaning system associated with the sensor unit.

34. The autonomous vehicle of claim 32, wherein the fan is activated in response to the perception system determining, based on the received sensor data, a precipitation condition.

35. The autonomous vehicle of claim 31, wherein the sensor is a cylindrical LiDAR and the duct is arranged to direct the air towards the sensor window to form an air curtain that extends 360 degrees around an axis defined by the cylindrical LiDAR.
